(19) United States
(12) Patent Application Publication
(10) Pub. No.: US 2006/0260292 A1
(43) Pub. Date: Nov. 23, 2006

(54) Gas turbine exhaust diffuser

(75) Inventor: Tadateru Tanioka, Takasago-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MITSUBISHI HEAVY INDUSTRIES, LTD., Tokyo (JP)

(21) Appl. No.: 11/353,251

(22) Filed: Feb. 14, 2006

(30) Foreign Application Priority Data
Apr. 28, 2005 (JP) 2005-130884

(51) Int. Cl. F02C 7/10

(52) U.S. Cl. 60/39.511

(57) ABSTRACT

A gas turbine exhaust diffuser, comprising: a flow liner for guiding a hot gas; a flow guide portion extending downstream of the flow liner; an exhaust casing cylindrical portion in a form of a thick plate disposed outwardly of the flow liner at a distance from the flow liner; and an exhaust hood outer tube portion in a form of a thin plate having an outward end portion connected to a downstream side of the exhaust casing cylindrical portion, and having an inward end portion connected to the flow guide portion, and wherein a heat insulating material is applied to outer surfaces of the exhaust casing cylindrical portion and the flow guide portion and to an inner surface of the exhaust hood outer tube portion.

### BACKGROUND OF THE INVENTION

1. Field of the Invention

This invention relates to a gas turbine exhaust diffuser. More specifically, the invention relates to a gas turbine exhaust diffuser which contributes to an improvement in the low cycle fatigue life of an exhaust diffuser in a gas turbine under thermal stress.

2. Description of the Related Art

FIG. 5 shows the entire configuration of an ordinary gas turbine for power generation. The reference numeral 20 denotes a compressor, 30 a combustion chamber, 40 a turbine, and50 an exhaust diffuser. This gas turbine compresses air, which has been taken in through an inlet located forward, by the compressor 20, then heats a fuel-air mixture in the combustion chamber 30, further straightens a flow of a combustion gas and obtains power in the turbine 40 located rearward, and finally discharges an exhaust through the exhaust diffuser 50 located in a rear portion.

The gas turbine is often used as a combined cycle system from the aspect of efficiency, and has a high exhaust gas (also called a hot gas) temperature. In the structural design of the exhaust diffuser 50, therefore, thermal stress in a transient stage at the start and stoppage of the gas turbine poses a problem, necessitating a measure for decreasing the thermal stress. Under these circumstances, various measures are taken to improve a low cycle fatigue life under thermal stress.

For example, a conventional gas turbine is provided with a sealing portion, which is easy to install, withstands a thermal expansion difference, and can seal an annular hollow portion, in order to prevent recirculation of a hot gas passing through the hollow portion formed between a flow liner on the outside of the exhaust diffuser and an exhaust cylindrical portion, and prevent an excessively high temperature in the exhaust cylindrical portion, thermal stress and deformation (see, for example, Japanese Patent Application Laid-Open No. 1993-52122).

In a center body for a gas turbine, a heat control device having a plurality of opening portions arranged in a circumferential direction is provided around the center body, thereby minimizing thermal stress between the surface of the exterior of the center body exposed to a flow of a hot gas and the interior of the center body where cooling air is led (see, for example, Japanese Patent Application Laid-Open No. 2001-271709).

Another measure is also taken: An exhaust duct is composed of an outer casing and an inner casing having through-holes bored in a diametrical direction. A connecting plate having through-holes and extending in the diametrical direction to secure the inner casing and the outer casing together is provided between the outer peripheral surface of the inner casing and the inner peripheral surface of the outer casing. Because of this configuration, local thermal deformation caused to the exhaust duct by a flow of a hot gas is diminished, and damage to the junction or the like in accordance with heat deformation is prevented (Japanese Patent Application Laid-Open No. 1997-133024).

In a gas turbine, moreover, a heat insulating material is provided on the outer surface of an exhaust diffuser in order to prevent heat dissipation to the outside and maintain thermal energy within the gas turbine. Such a conventional configuration is shown, for example, in FIG. 6. FIG. 6 shows details of a portion corresponding to a portion A in FIG. 5. The reference numeral 01 denotes an exhaust casing cylindrical portion (hereinafter referred to as the cylindrical portion 01), 02 denotes an exhaust hood outer tube portion (hereinafter referred to as the outer tube portion 02), 03 denotes a flow guide portion, 04 denotes a flow liner, 06 denotes an outer surface heat insulating portion, and 01a and 02a denote flanges.

The cylindrical portion 01 is formed of a thick plate and has a great heat capacity, while the outer tube portion 02 is formed of a thin plate and has a small heat capacity. A downstream side of the cylindrical portion 01 and an upstream side of the outer tube portion 02 are connected and fixed by bolts at the flanges 01a and 02a which the cylindrical portion 01 and the outer tube portion 02 have. When the gas turbine is started, a hot gas flows into the inside of the guide portion 03 and the flow liner 04. In accordance with this flow, the temperature of a space surrounded by the cylindrical portion 01, the outer portion 02, the flow guide portion 03, and the flow liner 04 rises to heat the cylindrical portion 01 and the outer tube portion 02.

FIG. 2-a shows the temperature changes of the cylindrical portion 01 and the outer tube portion 02 when the gas turbine is started and stopped. In FIG. 2-a, the values indicated by a solid line represent the temperature changes of the outer tube portion 02 which is formed of a thin plate, while the values indicated by a dashed line represent the temperature changes of the cylindrical portion 01 which is formed of a thick plate. The heat capacity is different between the cylindrical portion 01 and the outer tube portion 02 because of a difference in plate thickness or the like. In the configuration of FIG. 6 where the cylindrical portion 01 and the outer tube portion 02 are both placed in the same environment, therefore, the rates of their temperature changes are different to produce a metal temperature difference between the cylindrical portion 01 and the outer tube portion 02.

FIG. 2-b shows an example of changes overtime in stress which occurs in the junction between the cylindrical portion 01 and the outer tube portion 02. These stress changes are caused according to a difference in thermal expansion coefficient associated with a difference in the rate of temperature change between the cylindrical portion 01 and the outer tube portion 02. The stress occurring in the junction at the time of starting and stopping the gas turbine is problematical particularly at a transient stage.

In the case of the configuration as shown in FIG. 6, for example, there is a heat capacity difference between the cylindrical portion 01 and the outer tube portion 02 according to the difference in the plate thickness or the like, so that the temperature of the outer tube portion 02 rises more quickly than the cylindrical portion 01 when the gas turbine is started. Assume, for example, that stress occurring in the junction owing to this temperature difference is positive. When the gas turbine is stopped, the temperature of the outer tube portion 02 lowers more quickly than the cylindrical portion 01, so that stress occurring in the junction is negative.

As shown in FIG. 2-b, therefore, the value of the stress range may grow, thereby imposing load on the junction to cause damage thereto. Moreover, the outer surface heat insulating portion 06 is provided on the outer surface of the outer tube portion 02, so that heat dissipation cannot take place. Thus, at the time of starting the gas turbine, the evaluated metal temperature of the outer tube portion 02 may become even higher to render the temperature change greater. These problems are likely to shorten a low cycle fatigue life, as evidenced by cracking. Thus, it is very important to take a measure for decreasing thermal stress in a structure having a junction of members of different heat capacities bonded together.

For the configuration of the gas turbine shown in FIG. 6, therefore, a measure is taken, such as the use of materials having a low expansion coefficient and excellent resistance to high temperatures, or the incorporation of features as shown in FIG. 7. In FIG. 7, the reference numeral 01 denotes a cylindrical portion, 02 an outer tube portion, 03 a flow guide portion, 04 a flow liner, and 06 an outer surface heat insulating portion. This configuration of FIG. 7 is the configuration of FIG. 6 in which the plate thickness of the outer tube portion 02 has been continuously changed such that the plate thickness of the junction of the outer tube portion 02 with the cylindrical portion 01 and the plate thickness of the junction between the outer tube portion 02 and the flow guide portion 03 are large, and the plate thickness of a middle portion of the outer tube portion 02 is small. By so eliminating discontinuities in heat capacities and shapes at the junctions to reduce thermal stress and stress concentration, loads on the junctions are reduced. Explanations overlapping those offered above in connection with FIG. 6 are omitted.

The above configuration using materials having a low expansion coefficient and excellent resistance to high temperatures may be disadvantageous for the manufacturing cost. Even with the configuration shown in FIG. 7, a marked improvement in the low cycle fatigue life cannot be expected. In addition, the increased plate thickness of the outer tube portion 02 leads to increases in rigidity and thermal stress. Thus, the outer tube portion 02 needs to be formed as a thin plate in the range where vibration rigidity is established and, for this purpose, a cutting-out operation is required. This imposes restrictions on the shape and dimensions, thereby increasing costs for machining and manufacturing to increase the cost of production. If cracks occur in the outer tube portion 02, repair by welding creates discontinuities in the shape. As a result, the initial life is not restored. Thus, the defective components have to be replaced by new cut-out components during repair, thereby adding costs.

The present invention has been accomplished in light of the above-described problems with the earlier technologies. It is an object of the invention to provide a gas turbine exhaust diffuser which reduces the difference in heat capacity between the exhaust casing cylindrical portion and the exhaust hood outer tube portion to improve the low cycle fatigue life.

### SUMMARY OF THE INVENTION

An aspect of the present invention is a gas turbine exhaust diffuser, comprising:

a flow liner for guiding a hot gas;

a flow guide portion extending downstream of the flow liner;

an exhaust casing cylindrical portion in a form of a thick plate disposed outwardly of the flow liner at a distance from the flow liner; and

an exhaust hood outer tube portion in a form of a thin plate having an outward end portion connected to a downstream side of the exhaust casing cylindrical portion, and having an inward end portion connected to the flow guide portion, and

wherein a heat insulating material is applied to outer surfaces of the exhaust casing cylindrical portion and the flow guide portion and to an inner surface of the exhaust hood outer tube portion.

Another aspect of the invention is a gas turbine exhaust diffuser, comprising:

a flow liner for guiding a hot gas;

a flow guide portion extending downstream of the flow liner;

an exhaust casing cylindrical portion in a form of a thick plate disposed outwardly of the flow liner at a distance from the flow liner; and

an exhaust hood outer tube portion in a form of a thin plate having an outward end portion connected to a downstream side of the exhaust casing cylindrical portion, and having an inward end portion connected to the flow guide portion, and

wherein a heat insulating material is applied to an outer surface of the exhaust hood outer tube portion, as well as to outer surfaces of the exhaust casing cylindrical portion and the flow guide portion and to an inner surface of the exhaust hood outer tube portion.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a sectional view showing the configuration of portions in the vicinity of a junction between an exhaust casing cylindrical portion and an exhaust hood outer tube portion according to the present invention;

FIG. 2-a is a graph showing an example of metal temperature changes in a conventional configuration, FIG. 2-b is a graph showing an example of stress generated in the conventional configuration, FIG. 2-c is a graph showing metal temperature changes in the present invention, and FIG. 2-d is a graph showing stress generated in the present invention;

FIG. 3 is a sectional view showing a configuration according to Embodiment 1 of the present invention;

FIG. 4 is a sectional view showing a configuration according to Embodiment 2 of the present invention;

FIG. 5 is a side view, partly broken away, showing the configuration of an ordinary gas turbine;

FIG. 6 is a sectional view showing the configuration of portions in the vicinity of a junction between an exhaust casing cylindrical portion and an exhaust hood outer tube portion of a conventional gas turbine; and

FIG. 7 is a sectional view showing the configuration of portions in the vicinity of a junction between an exhaust casing cylindrical portion and an exhaust hood outer tube portion of another conventional gas turbine.

### DETAILED DESCRIPTION OF THE INVENTION

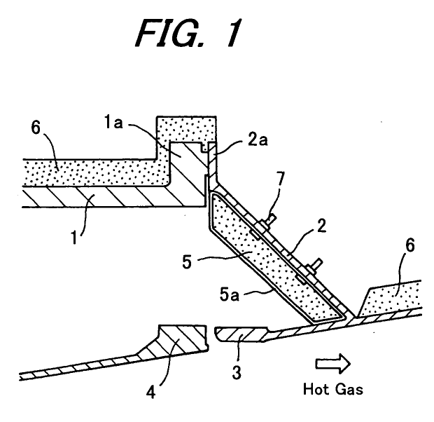

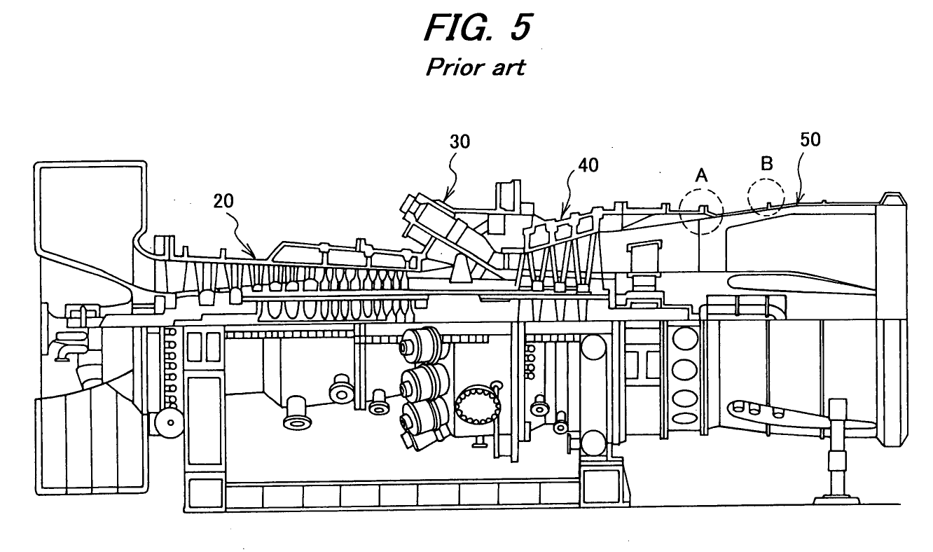

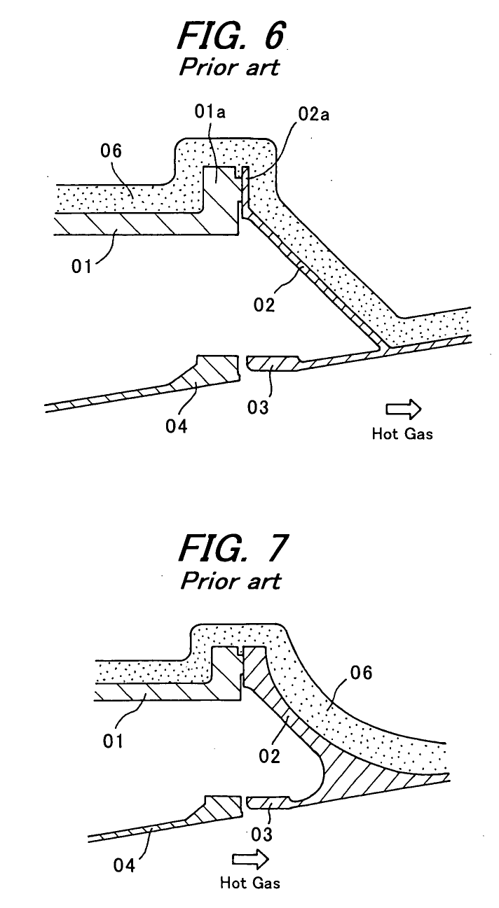

An embodiment, as the best mode, of a gas turbine exhaust diffuser according to the present invention will be described with reference to FIG. 1. FIG. 1 shows details of a portion corresponding to a portion A in FIG. 5. The reference numeral 1 denotes an exhaust casing cylindrical portion (hereinafter referred to as the cylindrical portion), 2 denotes an exhaust hood outer tube portion (hereinafter referred to as the outer tube portion), 3 denotes a flow guide portion, 4 denotes a flow liner, 5 denotes an inner surface heat insulating portion, 6 denotes an outer surface heat insulating portion, 7 denotes a bolt, 1a and 2a denote flanges, and 5a denotes a segment.

The cylindrical portion 1 is formed of a thick plate, and has the flange 1a on the downstream side thereof. The outer tube portion 2 is formed of a thin plate, and has the flange 2a on the upstream side thereof. The flow guide portion 3 extends downstream of the flow liner 4, and a clearance is provided between the flow guide portion 3 and the flow liner 4 for accommodating a thermal elongation difference. Further, the outer tube portion 2 is connected to the flange 1a of the cylindrical portion 1 and the outer peripheral surface of the flow guide portion 3, and the flange 1a and the flange 2a are bonded together by bolts (not shown). The flow liner 4 is disposed at a position spaced from the inside of the cylindrical portion 1.

The inner surface heat insulating portion 5 comprises a plurality of the segments 5a laid at intervals on the inner surface of the outer tube portion 2, the segments 5a each accommodating a heat insulating material therein. The heat insulating material is accommodated in the segments 5a so that the heat insulating material will not be blown off by a flow of a gas. The plural segments 5a provided in the divided manner are arranged at intervals in order to accommodate the thermal expansion differences between the outer tube portion 2 and the segments 5a by the intervals between the segments 5a and to prevent, for example, damage to the outer tube portion 2 and the segments 5a. The segments 5a are fixed to the outer tube portion 2 by the bolts 7.

The outer surface heat insulating portion 6 is provided on the outer surfaces of the cylindrical portion 1 and the flow guide portion 3, but is not provided on the outer surface of the outer tube portion 2, and is exposed to the outside air. The heat insulating material provided in the outer surface heat insulating portion 6 is unlikely to be blown off by a gas, and thus may be applied directly.

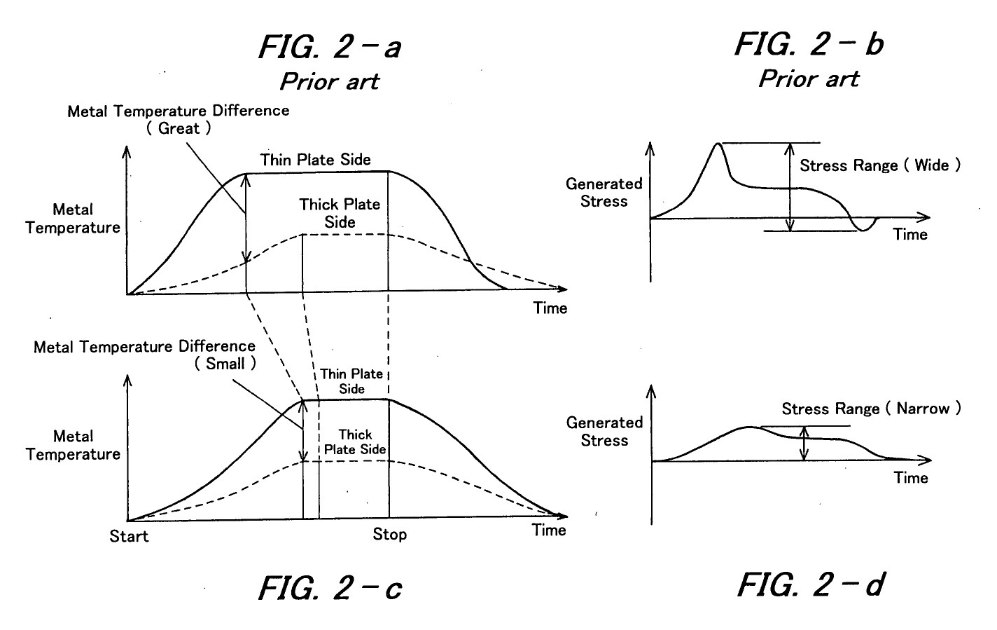

The actions of the present embodiment will be described. As shown in FIG. 2-c, when a hot gas flows in at the start of the gas turbine, the gas turbine according to the present embodiment acts in the following manner: The cylindrical portion 1 is made of a thick plate and has a great heat capacity, so that its temperature rises gently. On the other hand, the outer tube portion 2 is formed of a thin plate, but has the inner surface heat insulating portion 5 provided on the inner surface thereof, and has its outer surface directly exposed to the outside air. This configuration facilitates heat dissipation. Thus, it can be seen that the metal temperature change of the outer tube portion 2 is mild, and the metal temperature difference between the outer tube portion 2 and the cylindrical portion 1 is narrowed. In FIG. 2-c, the values indicated by the solid line represent the temperature changes of the outer tube portion 2 made of a thin plate, while the values indicated by the dashed line represent the temperature changes of the cylindrical portion 1 formed of a thick plate.

As shown in FIG. 2-d, therefore, a decrease is also observed in stress acting on the junction between the cylindrical portion 1 and the outer tube portion 2 because of the metal temperature difference therebetween at a transient stage at the time of start and stoppage of the gas turbine. This is proof that the present embodiment is effective for maintaining the junction between the cylindrical portion 1 and the outer tube portion 2. Furthermore, the stress range is narrowed, so that the stress imposed on the junction can be rendered lower.

Additionally, according to the present embodiment, the constituent members other than the heat insulating material require no change in shape, and thus have the advantage that they can be easily applied to existing machines. The heat insulating material used in the inner surface heat insulating portion 5 and the outer surface heat insulating portion 6 may be a material having heat resistance, such as a ceramic blanket or glass fibers. The outer tube portion 2 and the flow guide portion 3 need not be connected at an angle as shown in FIG. 1, but may be connected vertically, for example.

### EMBODIMENT 1

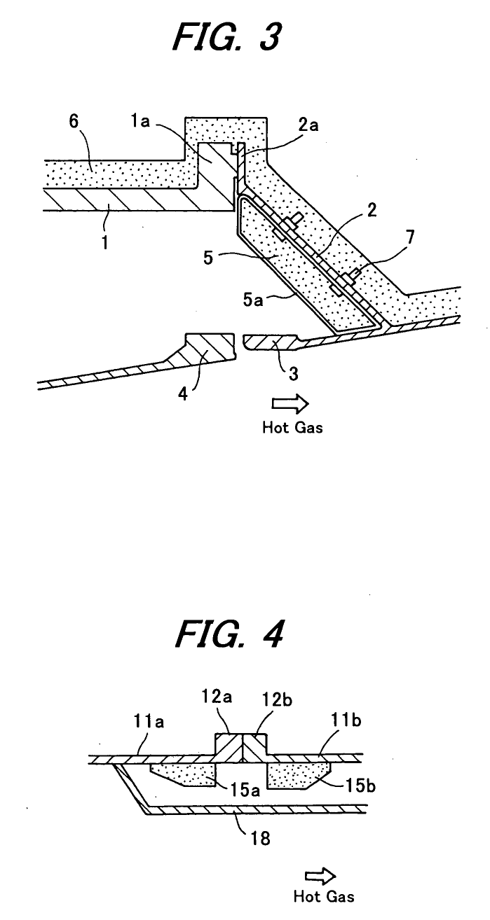

An embodiment of the present invention will be described with reference to FIG. 3. In FIG. 3, the reference numeral 1 denotes a cylindrical portion, 2 denotes an outer tube portion, 3 denotes a flow guide portion, 4 denotes a flow liner, 5 denotes an inne rsurface heat insulating portion, 6 denotes an outer surface heat insulating portion, 7 denotes a bolt, 1a and 2a denote flanges, and 5a denotes a segment. The present embodiment is the above-described embodiment as the best mode of the present invention in which the outer surface heat insulating portion 6 has been added to the outer surface of the outer tube portion 2. Explanations overlapping those offered in the aforementioned best mode are omitted.

In a plant, which has a gas turbine housed in an enclosure (not shown), and is placed under a controlled atmosphere for protection of a fire alarm and measuring instruments, heat dissipation from an exhaust diffuser may be a cause of a temperature rise in the enclosure, and this is improper. However, because of dimensional restrictions, for example, an adequate thickness of the inner surface heat insulating portion 5 may be impossible to ensure. In this case, a temperature rise within the enclosure maybe induced.

According to the gas turbine concerned with the present embodiment mentioned above, however, if a sufficient thickness of the inner surface heat insulating portion 5 is not obtained because of dimensional restrictions, etc., the outer surface heat insulating portion 6 is added to the outer surface of the outer tube portion 2. By so doing, heat dissipation to the enclosure can be prevented, whereby the temperature rise within the enclosure can be prevented.

### EMBODIMENT 2

A second embodiment of the present invention will be described with reference to FIG. 4. FIG. 4 is a view showing the configuration of a portion, for example, indicated by a range B enclosed with a dashed line in FIG. 5. In FIG. 4, 11a and 11b denote exhaust hood cylindrical portions (hereinafter referred to as thin plate portions 11a, 11b) 12a and 12b denote flanges, 15a and 15b denote inner surface heat insulating portions, and 18 denotes a flow guide. The flanges 12a and 12b are thick plates connected to the thin plate portions 11a and 11b. The inner surface heat insulating portions 15a and 15b are provided on the inner surfaces of the thin plate portions 11a and 11b, and are installed in such a manner as to become thinner as they are spaced from the flanges 12a and 12b. The changes in the thicknesses of the inner surface heat insulating portions 15a and 15b are intended to prevent discontinuous differences in heat capacity between the locations provided with the heat insulating material and the locations without the heat insulating material from being produced by applying the heat insulating material to the thin plate portions 11a and 11b. Besides, the flow guide 18 is provided along the inner surface heat insulating portions 15a and 15b, beginning at a site upstream thereof, so that the inner surface heat insulating portions 15a and 15b will not an impediment to the channel for a hot gas.

The above second embodiment of the present invention makes it possible to narrow heat capacity differences between the thin plate portions 11a and 11b and the flanges 12a and 12b, which are associated with a temperature rise caused by the hot gas when the gas turbine is started. Thus, damage or cracking can be prevented.

The present invention can be used at sites where stress occurs in junctions due to heat capacity differences, for example, not only the aforementioned junction between the exhaust casing cylindrical portion and the exhaust hood outer tube portion, but also the junction between the thick plate portion and the thin plate portion, namely, the junction between members of different heat capacities where a thermal expansion difference arises because of a difference in temperature change rate between the thick plate portion and the thin plate portion, for example, upon inflow of the hot gas. If the heat insulating material is provided on the inside of the flow liner, however, a flow guide or the like should desirably be provided to inhibit the heat insulating material from impeding the flow of the gas.

The invention thus described, it will be obvious that the same may be varied in many ways. In the above embodiments, for example, the configurations for decreasing the heat capacity difference are applied to the gas turbine exhaust diffuser. However, the configurations according to the present invention are not limited to exhaust diffusers, but can be used for decreasing a heat capacity difference between members having different heat capacities. Such variations are not to be regarded as a departure from the spirit and scope of the invention, and all such modifications as would be obvious to one skilled in the art are intended to be included within the scope of the following claims.

1. A gas turbine exhaust diffuser, comprising:
a flow liner for guiding a hot gas;
a flow guide portion extending downstream of the flow liner;
an exhaust casing cylindrical portion in a form of a thick plate disposed outwardly of the flow liner at a distance from the flow liner; and
an exhaust hood outer tube portion in a form of a thin plate having an outward end portion connected to a downstream side of the exhaust casing cylindrical portion, and having an inward end portion connected to the flow guide portion, and
wherein a heat insulating material is applied to outer surfaces of the exhaust casing cylindrical portion and the flow guide portion and to an inner surface of the exhaust hood outer tube portion.

2. A gas turbine exhaust diffuser, comprising:
a flow liner for guiding a hot gas;
a flow guide portion extending downstream of the flow liner;
an exhaust casing cylindrical portion in a form of a thick plate disposed outwardly of the flow liner at a distance from the flow liner; and
an exhaust hood outer tube portion in a form of a thin plate having an outward end portion connected to a downstream side of the exhaust casing cylindrical portion, and having an inward end portion connected to the flow guide portion, and
wherein a heat insulating material is applied to an outer surface of the exhaust hood outer tube portion, as well as to outer surfaces of the exhaust casing cylindrical portion and the flow guide portion and to an inner surface of the exhaust hood outer tube portion.
